(19) United States
(12) Patent Application Publication
(10) Pub. No.: US 2026/0154667 A1
(43) Pub. Date: Jun. 4, 2026

(54) NFC-BASED SELF-CHECKOUT SYSTEM

(71) Applicant: American Express Travel Related Services Company, Inc., New York, NY (US)

(72) Inventors: Alaric M. Eby, Scottsdale, AZ (US); Ajay Babu Maddukuri, Phoenix, AZ (US)

(21) Appl. No.: 18/967,814

(22) Filed: Dec. 4, 2024

(51) Int. Cl. G06Q 20/18; G06Q 20/32; G06Q 30/0601

(52) U.S. Cl. CPC G06Q 20/18; G06Q 20/3278; G06Q 30/0633

(57) ABSTRACT

Disclosed are various embodiments for an NFC-based self-checkout system. Embodiments can include a computing device comprising a near-field communication (NFC) reader. The computing device can obtain, via the NFC reader, a stock keeping unit (SKU) identifier for an item from an item NFC tag attached to the item. It can also obtain, via the NFC reader, a shopping cart identifier and a terminal identifier from a cart NFC tag attached to the shopping cart. It can then receive a user input indicating that a purchase of the item is to be completed. Subsequently, the computing device can establish a secure connection with a payment terminal service associated with the terminal identifier and send the SKU for the item, a payment instrument, and the shopping cart identifier to the payment terminal service.

### BACKGROUND

Self-checkout systems have been used by retailers for decades. These self-checkout systems allow customers to remove items from their cart, scan them, bag them, and pay for them without the need for a cashier to calculate and process the purchase. However, these self-checkout systems have their limitations. They are large, require regular maintenance, and can cause queues to form during busy periods as customers wait for the current customer using the self-checkout system to complete his or her transaction. Accordingly, there are upper limits on the number of customers per interval of time that a self-checkout system can be expected to process.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1-4 are drawings depicting an illustrative example of a user experience according to the various embodiments of the present disclosure.

FIG. 5 is a drawing of a network environment according to various embodiments of the present disclosure.

FIGS. 6 and 7 are sequence diagrams illustrating example of functionality implemented as portions of applications executed in the network environment of FIG. 5 according to various embodiments of the present disclosure.

### DETAILED DESCRIPTION

Disclosed are various approaches for a near-field communication (NFC) based self-checkout system or kiosk. In the various embodiments of the present disclosure, users can tap an NFC-enabled device (e.g., a mobile phone) to an NFC tag attached to a shopping cart of a store. The NFC tag can contain the necessary information to allow a wallet application on the client device to pay for any items added to the shopping cart. Once the payment is processed, a user can tap his or her phone to an exit system to confirm that he or she has paid for the items in his or her shopping cart in order to leave the premises of the merchant.

The system has technical benefits compared to current self-checkout systems. For example, there are no upper limits on the number of customers per interval of time that can use the various embodiments of the present disclosure. A traditional self-checkout system or kiosk, where users can scan, pay for, and bag their items in the checkout area of the store, might be limited to processing at most a certain number of customers per hour, on average, because only one customer at a time can use the traditional self-checkout system or kiosk. In contrast, if every customer in the store had a mobile device (e.g., a smartphone), then every customer in the store could simultaneously checkout using the various embodiments of the present disclosure. This increase in throughput provides a technical advantage over traditional self-checkout systems or kiosks currently employed by merchants and retailers.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

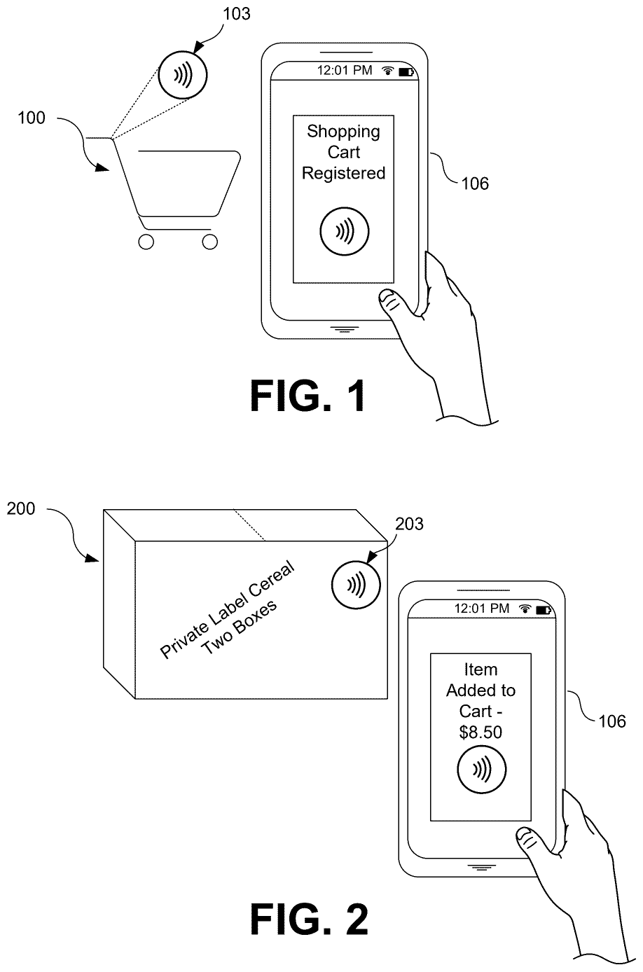

As illustrated in FIG. 1, a user can register a shopping cart 100 to use during his or her shopping experience (e.g., at the store of a merchant, such as a grocery store). For example, at the beginning of shopping journey for the user, the user could scan a cart near-field communications (NFC) tag 103 attached to a shopping cart with his or her client device 106 (e.g., mobile phone, smart watch or other wearable computing device, etc.). This registers a shopping cart with the user's client device 106, which allows both the client device 106 and the merchant to track which items 200 (FIG. 2) that the user intends to purchase at the end of the shopping experience.

Then, as illustrated in FIG. 2, if the user wishes to purchase an item 200, the user can scan an item NFC tag 203 with his or her client device 106. In response, the client device 106 can read information stored on the item NFC tag 203 and link the item 200 with the shopping cart 100 that the user had registered in FIG. 1. This information can be stored on the client device 106 until the time at which the user wishes to checkout. For example, a user walking through a grocery store could scan with his or her client device 106 multiple items 200, such as milk, bread, eggs, cereal, and lunch meat, thereby adding each item to his or her shopping cart 100.

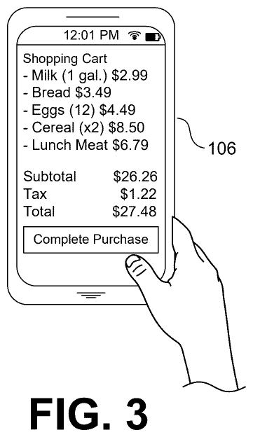

Once the user is finished shopping, the user can proceed to check out and complete his or her purchase on his or client device 106, as depicted in FIG. 3. The items 200 associated with the shopping cart 100 can be displayed, as well as additional information such as price, quantity, etc. The user can review the items 200 and confirm whether to proceed with the purchase, cancel the checkout in order to add more items 200, remove items 200, etc. Notably, the purchase can be completed at any location in the store or at any point in time.

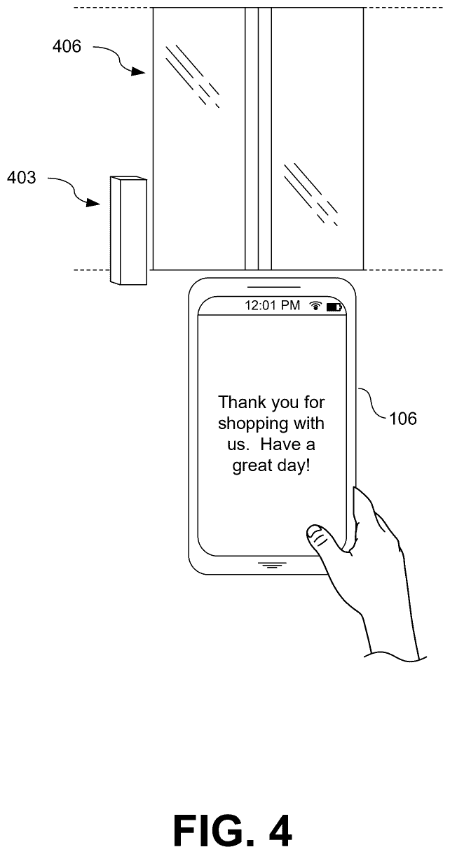

After completing the purchase, the user can proceed to exit the store as depicted in FIG. 4. As part of the exit process, the user can place his or her phone within proximity to an exit system 403. The exit system 403 can obtain, receive or retrieve the identifier of the shopping cart 100 of the user and determine whether the user has a complete a purchase involving the shopping cart 100. If the exit system 400 determines that the user has already completed his or her purchase, a confirmation can be shown on a display of the client device 106. The exit system 400 could then cause the doors to open so that the user can exit the premises. However, if the exit system 403 determines that the user has not made a purchase involving his or her shopping cart 100, the user could be prompted to complete a purchase before being allowed to exit the premises.

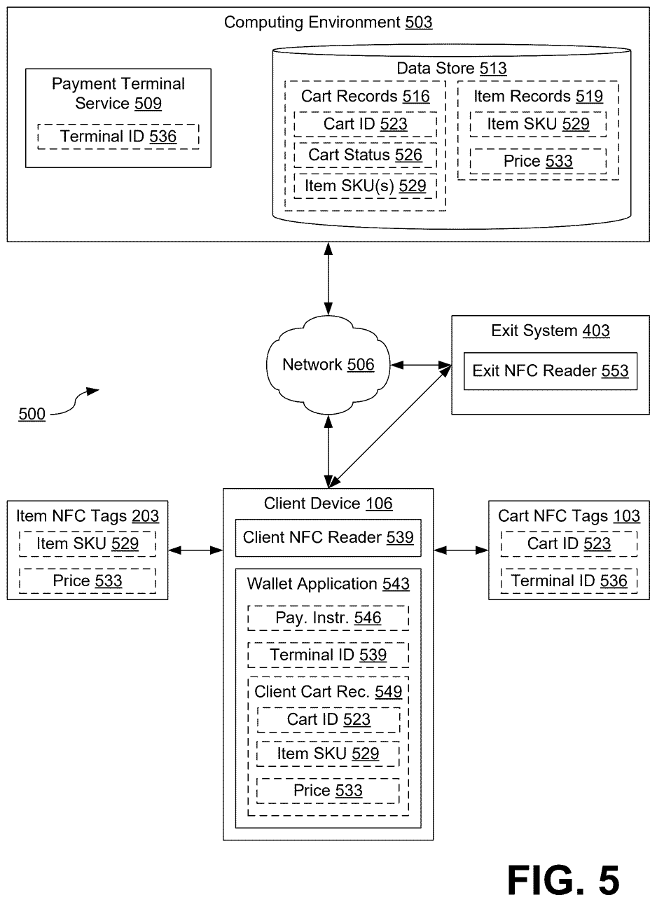

With reference to FIG. 5, shown is a network environment 500 according to various embodiments of the present disclosure. The network environment 500 can include a computing environment 503, a client device 106, an exit system 403, one or more cart NFC tags 103, one or more item NFC tags 203, and potentially other devices or services. The computing environment 503, exit system 403, and client device 106 can be in data communication with each other via the network 506. Separately, the client device 106 can, in some scenarios, be in direct data communication with one or more of the cart NFC tags 103, item NFC tags 203, or exit system 403.

The network 506 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 506 can also include a combination of two or more networks 506. Examples of networks 506 can include the Internet, intranets, extranets, virtual private networks (VPNs), and similar networks.

The computing environment 503 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 503 can employ a plurality of computing devices that can be arranged in one or more server banks or computer banks or other arrangements. Such computing devices can be located in a single installation or can be distributed among many different geographical locations. For example, the computing environment 503 can include a plurality of computing devices that together can include a hosted computing resource, a grid computing resource or any other distributed computing arrangement. In some cases, the computing environment 503 can correspond to an elastic computing resource where the allotted capacity of processing, network, storage, or other computing-related resources can vary over time.

Various applications or other functionality can be executed in the computing environment 503. The components executed on the computing environment 503 include the payment terminal service 509, and other applications, services, processes, systems, engines, or functionality not discussed in detail herein.

Also, various data is stored in a data store 513 that is accessible to the computing environment 503. The data store 513 can be representative of a plurality of data stores 513, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 513 is associated with the operation of the various applications or functional entities described below. This data can include one or more cart records 516, one or more item records 519 and potentially other data.

Each cart record 516 can be used as a virtual representation of a physical shopping cart 100. In some implementations, there can be a 1:1 relationship between an individual shopping cart 100 and a cart record 516. Each cart record 516 can include a cart identifier 523, a cart status 526, and one or more item stock keeping units (SKUs) 526. Items 200 can be associated with a cart record 200 in order to track which items 200 are to be purchased in a transaction. Accordingly, the cart identifier 523 can be any identifier that can uniquely identify one shopping cart 100 with respect to another, such as a decentralized identifier (DID), incrementally indexed counter, serial number, etc. The cart status 526 can be used to track the current state or status of a shopping cart 100 (e.g., registered or assigned to a user, paid, unpaid, etc.). The item SKUs 526 can be used to identify items 200 that have been associated with the shopping cart 100 (e.g., placed or collected in the cart by the user for later purchase).

Each item record 519 can represent information about an item 200 offered for sale. In some implementations, there can be a 1:n relationship between an individual item record 519 and the items 200 it represents (e.g., because the item 200 is fungible and multiple are in stock). Accordingly, an item record 519 can include an item SKU 529, the price 533 for the item, and potentially other information about the item 200. An item SKU 529 can represent any alphanumeric code that a retailer can assign to each product or item 200 to distinguish them from each other and manage inventor. For example, one dozen large eggs could be assigned one item SKU 529, while one dozen extra-large eggs could be assigned a second item SKU 529 and a half-dozen extra-large eggs are assigned a third item SKU 529.

The payment terminal service 509 can be executed to process payments for items 200 associated with a cart record 516. For scalability, a merchant could operate multiple instances of the payment terminal service 509 in order to process payments in parallel. Moreover, separate merchants could operate their own instances of the payment terminal service 509. Each payment terminal service 509 or instance of a payment terminal service 509 can include a terminal identifier 536, which can be used to uniquely identify a specific instance or collection of instances of the payment terminal service 509. The terminal identifier 536 could be represented in the form of a decentralized identifier (DID), uniform resource locator (URL), or other identifier.

The client device 106 is representative of a plurality of client devices 106 that can be coupled to the network 506. The client device 106 can include a processor-based system such as a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), or other devices with like capability. The client device 106 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the client device 106 or can be connected to the client device 106 through a wired or wireless connection.

The client device 106 can also include a client NFC reader 539. The client NFC reader 539 can be configured to detect the presence of other NFC enabled devices and obtain data from or provide data to the other NFC enabled devices. For example, the client NFC reader 539 could allow the client device 106 to read information stored on NFC tags such as cart NFC tags 103 and item NFC tags 203. As another example, the client NFC reader 539 could allow the client device 106 communicate and exchange data with the exit system 403.

The client device 106 can be configured to execute various applications such as a wallet application 543 or other applications. The wallet application 543 can be configured to store payment information related to one or more payment instruments 546 and make payments using the stored payment instruments 546 on behalf of the user. A payment instrument 546 can represent information related to any instrument that can be used to make a payment. Examples of payment instruments 546 can include credit cards, debit cards, charge cards, stored-value payment instruments (e.g., gift cards), demand deposit accounts (e.g., checking accounts, savings accounts, money market accounts, etc.), account-to-account payment platforms (e.g., PAYPAL® accounts, VENMO® accounts, etc.), or other mechanisms. Accordingly, the wallet application 543 can store payment information related to payment instrument 546 such as a credit, debit, or charge card number (or token or virtual card number that represents the credit, debit, or charge card number), expiration date, card verification value (CVV) or card security code (CSC), etc.

The wallet application 543 can also obtain and store information about items 200 that a user of the wallet application 543 wishes to purchase during a shopping session or journey (e.g., while shopping in a store). This information can include a client cart record 549, which can represent an individual shopping cart 200 associated with the wallet application 543. The client cart record 549 can include a cart identifier 523 for the associated shopping cart 100, which could be obtained from scanning a cart NFC tag 103 of the shopping cart 100. The client cart record 549 can also include information such as item SKUs 529 of items 200 and respective prices 533, which could be obtained from scanning one or more respective item NFC tags 203. The client cart record 549 could also include additional information, such as a running total or subtotal for the price of all the items 200 associated with the shopping cart 200 represented by the client cart record 549.

The exit system 403 can include any system which controls the egress or exit for shoppers from a merchant. The purpose of the exit system 403 is to verify that a customer leaving a merchant has paid for the goods or services that the user has in his or her possession. For example, the exit system 403 may be configured to open automatic doors after the user has verified that he or she has paid for the goods or services that the user has in his or her possession. Accordingly, the exit system 403 can include an exit NFC reader 549, which can be configured to detect the presence of other NFC enabled devices and exchange data with them (e.g., detect the presence of and exchange data with the client NFC reader 539 of the client device 106).

Next, a general description of the operation of the various components of the network environment 500 is provided. The following description provides but one example of the various interactions between the components of the network environment 500. Other interactions are also encompassed by the various embodiments of the present disclosure.

To begin, a user can enter a store to shop for one or more items 200. To enable use of the various embodiments of the present disclosure, the user can grab a shopping cart 100 with a cart NFC tag 103 affixed to it. The user can then tap or otherwise place his or her client device 106 with a client NFC reader 539 in proximity to the cart NFC tag 103, thereby enabling the wallet application 543 on the client device 106 to obtain the cart identifier 523 of the shopping cart 100 to use for tracking items 200 to be purchased and the terminal identifier 536 of the payment terminal service 509 to be used for completing a purchase of any items 200.

As the user peruses the merchant's store, the user can select items 200 for purchase. As part of the selection process, the user can tap or otherwise place his or her client device 106 with a client NFC reader 539 in proximity to the item NFC tag 203 of each item 200 he or she wishes to purchase, thereby enabling the wallet application 543 to obtain the item SKU 529, price 533, and quantity of the item 200 to be purchase (e.g., if a user taps multiple times, this could indicate a desire to purchase multiple ones of the item 200).

Subsequently, the user can elect to make a payment for the items 200 that he or she has placed in his or her shopping cart 100. As part of the payment process, the user could select a payment instrument 546 to use for the transaction. The wallet application 543 can then send the payment instrument 546, cart identifier 523, item SKUs 529, and quantity to the payment terminal service 509 identified by the terminal identifier 536 obtained from the cart NFC tag 103.

In response, the payment terminal service 509 can process and authorize the transaction. This can include updating the cart status 526 of the cart record 516 for the shopping cart 100 to reflect that the items 200 have been paid for. The payment terminal service 509 could also generate and return a receipt to the user.

When the user wishes to leave the premises, the user can authenticate with an exit security system 403 to indicate that he or she has paid for the items in his or her shopping cart 100. Accordingly, the user could tap or otherwise place his or her client device 106 with a client NFC reader 539 in proximity to the exit NFC reader 553 of the exit system 403. The wallet application 543 could share the cart identifier 523 with the exit system 403. The exit system 403, in turn, could verify the cart status 526 with the payment terminal service 509 in order to determine if the user has purchased the items 200 he or she is attempting to leave with. In response to receiving a confirmation that the items 200 have been paid for, the exit system 403 can permit the user to leave the premises (e.g., by causing automatic doors to open on behalf of the user). The exit system 403 can also send a confirmation message to the payment terminal service 509 to reset the cart status 526 so that the shopping cart 100 can be reused by a future customer.

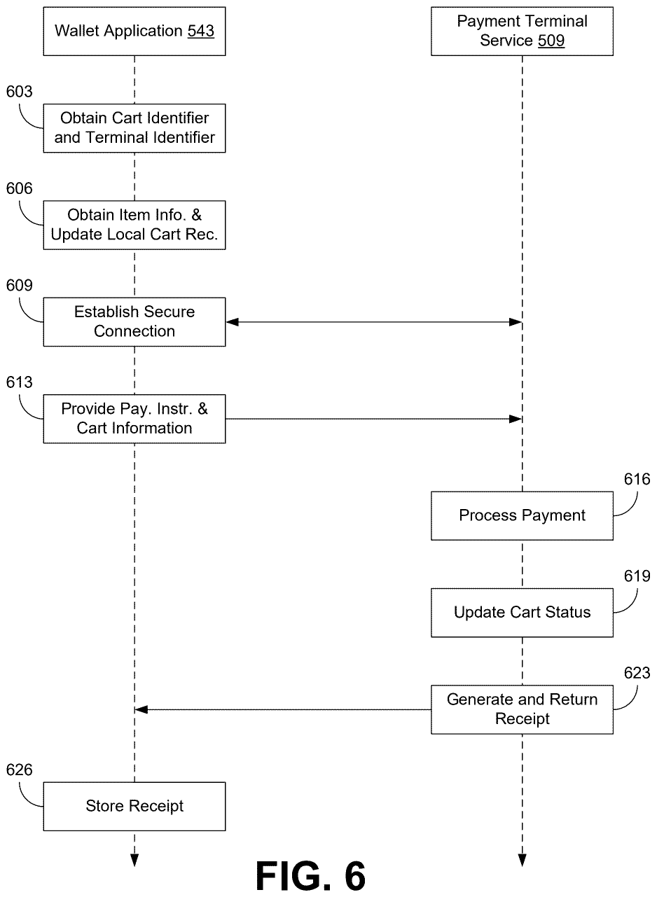

Referring next to FIG. 6, shown is a sequence diagram that provides one example of the interactions between the wallet application 543 and the payment terminal service 509. The sequence diagram of FIG. 6 provides merely an example of the many different types of functional arrangements that can be employed to implement the operations of the depicted portions of the wallet application 543 and payment terminal service 509. As an alternative, the sequence diagram of FIG. 6 can be viewed as depicting an example of elements of a method implemented within the network environment 500.

Beginning with block 603, the wallet application 543 can obtain the cart identifier 523 and the terminal identifier 536 to use for a shopping journey. For example, a user could tap or place his or her client device 106 in proximity to a cart NFC tag 103. In response, the client device 106 could use the client NFC reader 539 to read the cart NFC tag 103, obtain the cart identifier 523 of the shopping cart 100 and terminal identifier 536 of the payment terminal service 509, and provide this information to the wallet application 543.

Then, at block 606, the wallet application 543 can obtain an item SKU 529 and a price 533 of an item 200 to add to the shopping cart 100. For example, while walking through a store, the user could tap or place his or her client device 106 in proximity to an item NFC tag 203 of an item 200 that he or she intends to purchase. In response, the client device 106 could use the client NFC reader 539 to read the cart item NFC tag 203, obtain the item SKU 529 and the price 533 of the item 200, and provide this information to the wallet application 543. Tapping the item NFC tag 203 could cause the wallet application 543 to add additional instances of the item 200 to the shopping cart 100 by associating additional instances of the item SKU 529 with the client cart record 549 or by increasing the quantity associated with the item SKU 529.

In some instances, the wallet application 543 can display a list of items 200 added to the shopping cart 100 and a current total or subtotal amount. As additional item NFC tags 203 are scanned, the list of items 200 can be updated to reflect the addition, including updates to the total or subtotaled amount. This information can be presented to the user when requested.

Next, at block 609, the wallet application 543 can establish a secure connection with the payment terminal service 509 identified by the terminal identifier 536 obtained at block 603. For example, the wallet application 543 could use a decentralized identifier (DID) that represents the payment terminal service 509 to establish a secure DIDComm session with the payment terminal service 509. As another example, if the terminal identifier 536 were a URL, the wallet application 543 could establish secured hypertext transfer protocol (https) session with the payment terminal service 509 identified by the URL. In some instances, the secure connection can be established automatically in response to a triggering event, such as automatically in response to scanning a cart NFC tag 103 (e.g., at block 603). In other instances, the secure connection can be established in response to a user input or interaction (e.g., a user input or interaction indicating an intent to pay for the items 200 associated with the shopping cart 100).

Then, at block 613, the wallet application 543 can provide the payment instrument 546 and information stored in the client cart record 549 to the payment terminal service 509 in response to a user input or interaction indicating an intent to pay for the items 200 associated with the shopping cart 100. For example, the wallet application 543 could provide payment information that represents a credit or debit card to the payment terminal service 509 as well as a list of item SKUs 529 for items 200 scanned by the user and respective quantities for the item SKUs 529 (e.g., one of a first item, four of a second item, etc.). In some instances, the user could have multiple payment instruments 546 stored with the wallet application 543, such as when the user has multiple credit cards and/or debit cards. In these instances, the wallet application 543 could prompt the user to select the preferred payment instrument 546 to use for the transaction and submit the selected payment instrument 546 to the payment terminal service 509.

Accordingly, at block 616, the payment terminal service 509 can process the payment. For example, it can use the item SKU's 529 submitted to retrieve prices 533 from item records 519 stored in the data store 513 in order to confirm the amount of the transaction submitted by the wallet application 543. The payment terminal service 509 can also submit a transaction authorization request to the issuer of the payment instrument 546 submitted by the wallet application 543.

Assuming that the payment is approved, the payment terminal service 509 can update the cart status 526 of the cart record 516 of the shopping cart 100 to reflect that the items 200 in the shopping cart 100 have been purchased. For example, if the cart status 526 were represented as a Boolean value, it could be updated from a zero (indicating that the items 200 have not been paid for) to a one (to reflect that the items 200 have been paid for). However, other status indicators could also be used by various embodiments of the present disclosure.

Then, at block 623, the payment terminal service 509 can generate and return a receipt to the wallet application 543. The receipt can include information such as the date and time of the transaction, the items 200 purchased, the price 533 of each item 200 purchased, the quantity of each item 200 purchased, the payment instrument 546 used, and potentially other information. A copy of the receipt can also be stored by the payment terminal service 509 (e.g., in the data store 513) in case the receipt is needed for future reference.

Subsequently, at block 626, the wallet application 626 can receive the receipt and store a copy of the receipt. Should the user or customer have to make a return or exchange with the merchant in the future, the user can retrieve the receipt using the wallet application 543 and present it to the merchant for review.

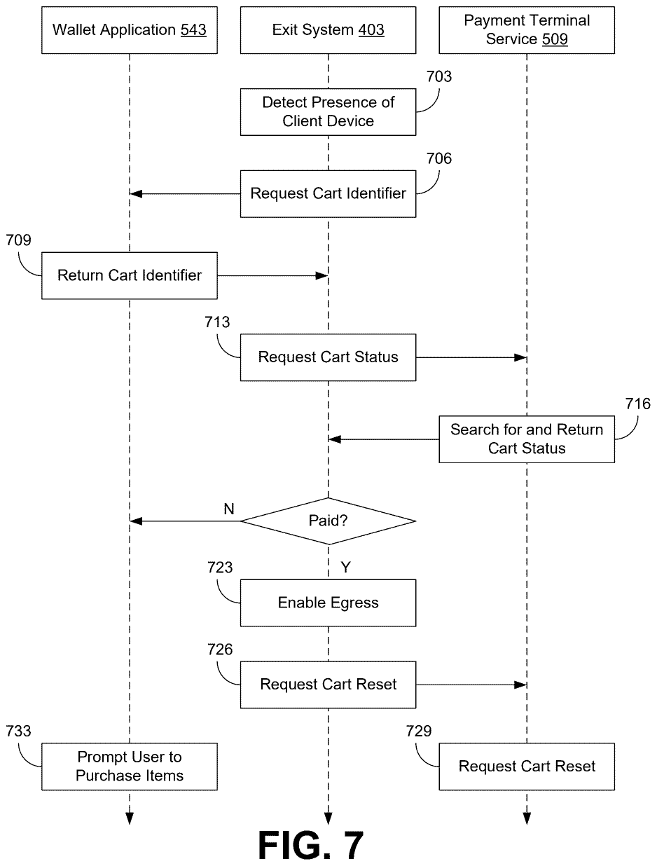

Referring next to FIG. 7, shown is a sequence diagram that provides one example of the interactions between the wallet application 543, and the payment terminal service 509, and the exit system 400. The sequence diagram of FIG. 7 provides merely an example of the many different types of functional arrangements that can be employed to implement the operations of the depicted portions of the wallet application 543, and the payment terminal service 509, and the exit system 400. As an alternative, the sequence diagram of FIG. 6 can be viewed as depicting an example of elements of a method implemented within the network environment 500.

Beginning with block 703, the exit system 403 can detect the presence of a client device 106. This could occur, for example, when a customer places his or her client device 106 next to the exit NFC reader 553 of the exit system 403 in order to confirm his or her purchases in order to leave the merchant's store or location.

Accordingly, at block 706, the exit system 403 can request the cart identifier 523 of the shopping cart 100 associated with the client device 106 and/or the items 200 that the user has purchased. The request could be sent using an NFC connection established between the client NFC reader 539 of the client device 106 and the exit NFC reader 553 of the exit system 403. The exit system 403 can also request the terminal identifier 536 of the payment terminal service 509 used to process the transaction.

At block 709, the wallet application 543 can receive the request and return the cart identifier 523 and/or terminal identifier 536 to the exit system 403. In some implementations, the wallet application 543 can show notification to the user on a display of the client device 106. This could be done, for example, in order to notify the user of the nature of the data exchange and/or to obtain the user's consent.

Then, at block 713, the wallet application 543 can request from the payment terminal service 509 the cart status 526 of the shopping cart 100 associated with the cart identifier 523 returned by the wallet application 543. Accordingly, the request can include the cart identifier 523. In some instances, the exit system 403 can use the terminal identifier 536 to identify the payment terminal service 509 to send the request to. In these instances, the exit system 403 could establish a secure connection with the payment terminal service 509 (e.g., a DIDComm connection or an HTTPS session) for the purpose of sending the request. In other instances, however, the exit system 403 could be preconfigured to send the request to a particular payment terminal service 509 (e.g., the payment terminal service 509 associated with the merchant operating the location where the exit system 403 is deployed).

Next, at block 716, the payment terminal service 509 can search for and return the current cart status 526 of the shopping cart 100. For example, the payment terminal service 509 can search the data store 513 using the cart identifier 523 to find a cart record 516 with a matching cart identifier 523. The payment terminal service 509 could then retrieve the cart status 526 from the identified cart record 516 and return the cart status 526 to the exit system 403.

Moving on to block 719, the exit system 403 can then determine the cart status 526. For example, the exit system 403 could determine that the cart status 526 indicates that the items 200 associated with the shopping cart 100 have been purchased (e.g., if the Boolean value representing the cart status 526 is equal to a value of one). In this example, the exit system 403 could proceed to block 723. However, if the exit system 403 determined that the cart status 526 indicated that the items 200 have not been paid for (e.g., if the Boolean value representing the cart status 526 is equal to a value of zero), then the exit system 403 could send a message or notification to the wallet application 543 via the NFC connection established between the client device 106 and the exit system 403. The process would then skip to block 733.

If the process proceeds to block 723, the exit system 403 can enable egress from the merchant location. For example, the exit system 403 could cause automatic doors to open to allow the customer to leave the premises.

Once the user has been permitted to leave the premises, the exit system 403 can send a request message to the payment terminal service 509 to reset the cart status 526. The message can include the cart identifier 523 of the shopping cart 100 of the departing user. This can be done so that the shopping cart 100 can be reused by future customers.

Accordingly, at block 729, the payment terminal service 509 can reset the cart status 526 of the cart record 516 that matches the cart identifier 523 provided at block 726. For example, if the Boolean value representing the cart status 526 was equal to a value of one (indicating that the items associated with the shopping cart 100 had been purchased), then the Boolean value could be change to zero (indicating that any items placed in the cart in the future have not been paid for). Any item SKU's 529 associated with the cart record 516 could be removed and any other data stored as part of the card record 516 can also be deleted or otherwise reset to a default value.

However, if the process proceeds to block 733, the exit system 403 could send an error message to the wallet application 543 indicating that the user is trying to leave without paying. Accordingly, at block 726, the wallet application 543 could prompt the user to purchase the items 200 associated with his or her shopping cart 100. Until the user pays for the items 200, or otherwise resolves the issue, the exit system 403 could decline to open any automatic doors or otherwise permit the user to leave the premises.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor, a memory, and a near-field communication (NFC) reader; and
machine-readable instructions stored in the memory that, when executed by the processor, cause the computing device to at least:
obtain, via the NFC reader, a stock keeping unit (SKU) identifier for an item from an item NFC tag attached to the item;
obtain, via the NFC reader, a shopping cart identifier and a terminal identifier from a cart NFC tag attached to the shopping cart;
receive a user input indicating that a purchase of the item is to be completed;
establish a secure connection with a payment terminal service associated with the terminal identifier; and
send the SKU for the item, a payment instrument, and the shopping cart identifier to the payment terminal service via the secure connection.

2. The system of claim 1, wherein the terminal identifier is a decentralized identifier (DID) and the secure connection is a DIDComm connection.

3. The system of claim 1, wherein the machine-readable instructions, when executed by the processor, further cause the computing device to at least:
obtain a price for the item from the item NFC tag attached to the item; and
update a subtotal for the shopping cart based at least in part on the price for the item.

4. The system of claim 1, wherein the machine-readable instructions further cause the computing device to at least:
receive a request, via the NFC reader, for the shopping cart identifier from an exit security system; and
provide, via the NFC reader, the shopping cart identifier to the exit security system.

5. The system of claim 4, wherein the exit security system is configured to confirm that the item associated with the shopping cart has been paid for.

6. The system of claim 1, wherein the machine-readable instructions further cause the computing device to at least link the SKU for the item to the shopping cart identifier.

7. The system of claim 1, wherein the machine-readable instructions further cause the computing device to at least receive a user input indicating a selection of the payment instrument from a plurality of stored payment instruments.

8. A method, comprising:
obtaining, via a near-field communications (NFC) reader, a stock keeping unit (SKU) identifier for an item from an item NFC tag attached to the item;
obtain, via the NFC reader, a shopping cart identifier and a terminal identifier from a cart NFC tag attached to the shopping cart;
receive a user input indicating that a purchase of the item is to be completed;
establish a secure connection with a payment terminal service associated with the terminal identifier; and
send the SKU for the item, a payment instrument, and the shopping cart identifier to the payment terminal service via the secure connection.

9. The method of claim 8, wherein the terminal identifier is a decentralized identifier (DID) and the secure connection is a DIDComm connection.

10. The method of claim 8, further comprising:
obtaining a price for the item from the item NFC tag attached to the item; and
updating a subtotal for the shopping cart based at least in part on the price for the item.

11. The method of claim 8, further comprising:
receiving a request, via the NFC reader, for the shopping cart identifier from an exit security system; and
provide, via the wireless connection, the shopping cart identifier to the exit security system.

12. The method of claim 11, wherein the exit security system is configured to confirm that the item associated with the shopping cart has been paid for.

13. The method of claim 8, further comprising linking the SKU for the item to the shopping cart identifier.

14. The method of claim 8, further comprising receiving a user input indicating a selection of the payment instrument from a plurality of stored payment instruments

15. A non-transitory, computer-readable medium, comprising machine-readable instructions that, when executed by a processor of a computing device that comprises a near-field communication (NFC) reader, cause the computing device to at least:
obtain, via the NFC reader, a stock keeping unit (SKU) identifier for an item from an item NFC tag attached to the item;
obtain, via the NFC reader, a shopping cart identifier and a terminal identifier from a cart NFC tag attached to the shopping cart;
receive a user input indicating that a purchase of the item is to be completed;
establish a secure connection with a payment terminal service associated with the terminal identifier; and
send the SKU for the item, a payment instrument, and the shopping cart identifier to the payment terminal service via the secure connection.

16. The non-transitory, computer-readable medium of claim 15, wherein the terminal identifier is a decentralized identifier (DID) and the secure connection is a DIDComm connection.

17. The non-transitory, computer-readable medium of claim 15, wherein the machine-readable instructions, when executed by the processor, further cause the computing device to at least:
obtain a price for the item from the item NFC tag attached to the item; and
update a subtotal for the shopping cart based at least in part on the price for the item.

18. The non-transitory, computer-readable medium of claim 15, wherein the machine-readable instructions further cause the computing device to at least:
receive a request, via the NFC reader, for the shopping cart identifier from an exit security system; and
provide, via the NFC reader, the shopping cart identifier to the exit security system.

19. The non-transitory, computer-readable medium of claim 15, wherein the machine-readable instructions further cause the computing device to at least link the SKU for the item to the shopping cart identifier.

20. The non-transitory, computer-readable medium of claim 15, wherein the machine-readable instructions further cause the computing device to at least receive a user input indicating a selection of the payment instrument from a plurality of stored payment instruments.
